(19) United States
(12) Patent Application Publication
(10) Pub. No.: US 2018/0299270 A1
(43) Pub. Date: Oct. 18, 2018

(54) MEMS DEVICE

(71) Applicant: RICHTEK TECHNOLOGY CORPORATION, Zhubei City (TW)

(72) Inventors: Chia-Yu Wu, Kaohsiung (TW); Chiung-Cheng Lo, Zhunan Township (TW)

(21) Appl. No.: 15/596,857

(22) Filed: May 16, 2017

(30) Foreign Application Priority Data
Apr. 18, 2017 (CN) 201710252496.5

(51) Int. Cl. G01C 19/5726; G01C 19/5755

(52) U.S. Cl. CPC G01C 19/5726; G01C 19/5755

(57) ABSTRACT

A MEMS (Micro-Electro-Mechanical System) device includes: a substrate, including an anchor; a proof mass, including a centroid, wherein there is a distance between the centroid and the anchor; at least two spring assemblies, connected between two opposite sides of the anchor and the proof mass, to assist a motion of the proof mass; and plural sensing capacitances, located between the substrate and the proof mass to operably sense the motion of the mass; wherein each of the spring assemblies includes a parallel-swing spring and a compression spring which are serially connected to each other.

### CROSS REFERENCE

The present invention claims priority to CN application no. 201710252496.5, filed on Apr. 18, 2017.

### BACKGROUND OF THE INVENTION

### Field of Invention

The present invention relates to a MEMS (Micro-Electro-Mechanical System) device, especially a MEMS device including a parallel-swing spring and a compression spring which are connected in series, such that a proof mass of the MEMS device can perform an in-plane motion and/or an out-of-plane torsion motion.

### Description of Related Art

FIG. 1 shows a prior art MEMS device according to U.S. Pat. No. 6,845,670, wherein the proof mass 12 is connected to a substrate through several anchors. When the MEMS device is subject to a temperature variation, the temperature coefficient offset in the substrate can propagate through the anchors 111 to the proof mass 12, to cause a deformation in the proof mass 12. The deformation can adversely affect the sensing result obtained according to a motion of the proof mass.

What is disclosed in the prior art of FIG. 1 is a single proof mass for sensing an in-plane motion and an out-of-plane torsion motion by an eccentric layout. However, because of the eccentric layout, when there is an out-of-plane torsion motion, the spring connecting the single proof mass and the anchor will have a lateral offset, whereby motions in different directions are coupled together to reduce sensing sensitivity.

In order to avoid the aforementioned problem of motion-coupling, in another prior art MEMS device 20 (FIG. 2, according to U.S. Pat. No. 8,333,113), different proof masses 121, 122, and 123 are provided for respectively sensing the motions in different directions. However, the multiple proof masses occupy more space than the single proof mass. Further, the sensing capacitors 14 are located far from the anchor 111, so the temperature coefficient offset in the substrate can affect the matching between the top electrodes and the bottom electrodes of the sensing capacitor 14, causing uncertainty of the sensing accuracy.

### SUMMARY OF THE INVENTION

In one perspective, the present invention provides a MEMS device. The MEMS device includes: a substrate, including an anchor; a proof mass, including a centroid, the centroid being away from the anchor by a distance; at least two spring assemblies, respectively connected between the proof mass and two opposite sides of the anchor, to assist a motion of the proof mass, wherein each of the spring assemblies includes a parallel-swing spring and a compression spring which are connected in series; and a plurality of sensing capacitators, located between the substrate and the proof mass, to sense the motion of the proof mass.

In one embodiment, In one embodiment, the MEMS device further includes a reference line passing through the anchor, wherein the spring assemblies are mirror-symmetrical with respect to the reference line, and the sensing capacitators are mirror-symmetrical with respect to the reference line.

In one embodiment, the motion of the proof mass includes: an in-plane motion, an out-of-plane torsion motion, or a combination of the in-plane motion and the out-of-plane torsion motion, wherein the in-plane motion is parallel to an in-plane direction with respect to the substrate and the out-of-plane torsion motion is parallel to an out-of-plane direction with respect to the substrate.

In one embodiment, the sensing capacitors include a plurality of in-plane sensing capacitators and a plurality of out-of-plane sensing capacitators, and a portion of the proof mass surrounds an outer periphery of the in-plane sensing capacitators.

In embodiment, the out-of-plane sensing capacitators are located between the substrate and two lateral side portions of the proof mass.

In one embodiment, the in-plane motion includes two in-plane motion directions which are mutually perpendicular to each other. The motion direction of the out-of-plane torsion motion is parallel to an out-of-plane direction of the substrate.

In one embodiment, the parallel-swing spring includes at least two linear springs which are parallel to each other.

In one embodiment, the compression spring includes: an S-type spring or a square ring spring.

In one embodiment, the two spring assemblies respectively directly connect two opposite sides of the anchor.

In one embodiment, the anchor is located in a center area of the substrate.

In one embodiment, the proof mass is one-integral-piece mass structure of one same material with direct connection between all portions of the proof mass.

In one embodiment, the spring assemblies directly connect the anchor without any linkage between the anchor and the spring assemblies.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art MEMS device.

FIG. 2 shows another prior art MEMS device.

FIG. 3 shows the MEMS device according to one embodiment of the present invention.

FIGS. 4A and 4B respectively show the spring assemblies according to two embodiments of the present invention.

FIGS. 5A, 5B, and 5C respectively show different motion statuses of the proof mass according to several embodiments of the present invention.

FIG. 6 shows the motions of the proof mass with limited motion-coupling effects according to one embodiment of the present invention.

FIGS. 7 and 8 show the MEMS devices according to two embodiments of the present invention.

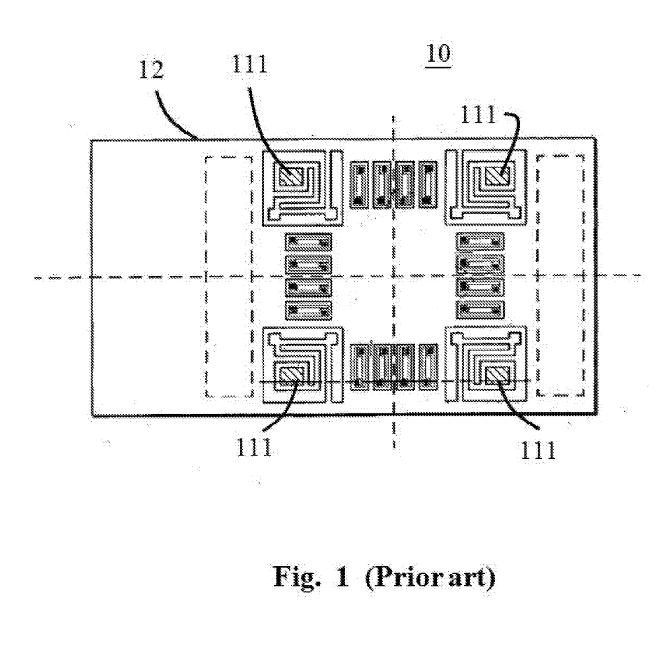

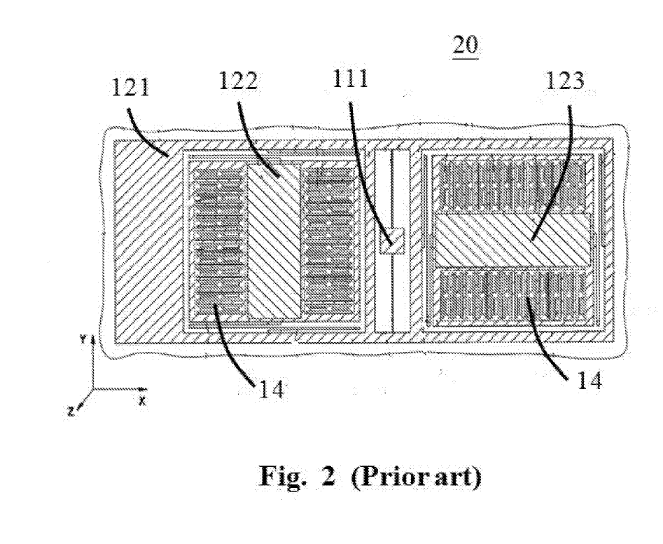

### DESCRIPTION OF THE PREFERRED EMBODIMENTS

The drawings as referred to throughout the description of the present invention are for illustrative purpose only, to show the interrelations between the components, but not drawn according to actual scale.

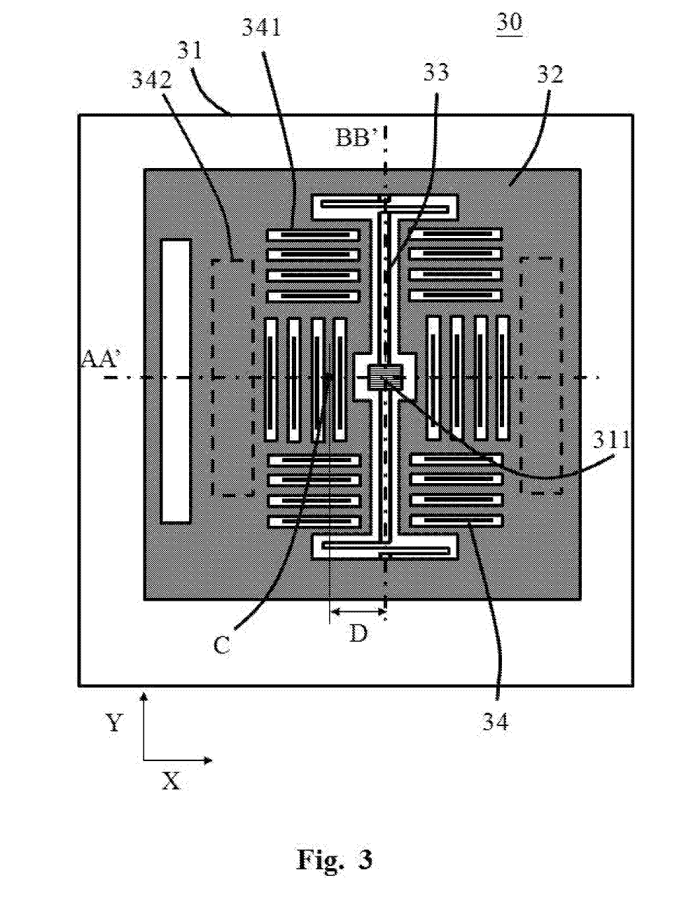

FIG. 3 shows a top view of the MEMS device 30 corresponding to one embodiment of the present invention. The MEMS device 30 includes: a substrate 31, including an anchor 311; a proof mass 32, including a centroid C, the centroid C being away from the anchor by a distance D; at least two spring assemblies 33, respectively connected between the proof mass 32 and two opposite sides of the anchor 311, to assist a motion of the proof mass 32, wherein each of the spring assemblies 33 includes a parallel-swing spring 331 and a compression spring 332 which are connected series to each other; and a plurality of sensing capacitators 34, located between the substrate 31 and the proof mass 32, to sense the motion of the proof mass 32. The proof mass 32 is connected to the substrate 31 only through the spring assemblies 33 and the anchor 311, without any other components.

In FIG. 3, the distance D between the centroid C and the anchor 311, is the distance between the centroid C and the anchor 311 when the proof mass 32 in a static status. When the proof mass 32 is in motion, there is a variation of the distance but the variation is ignorable and does not affect the eccentric motion of the proof mass 32.

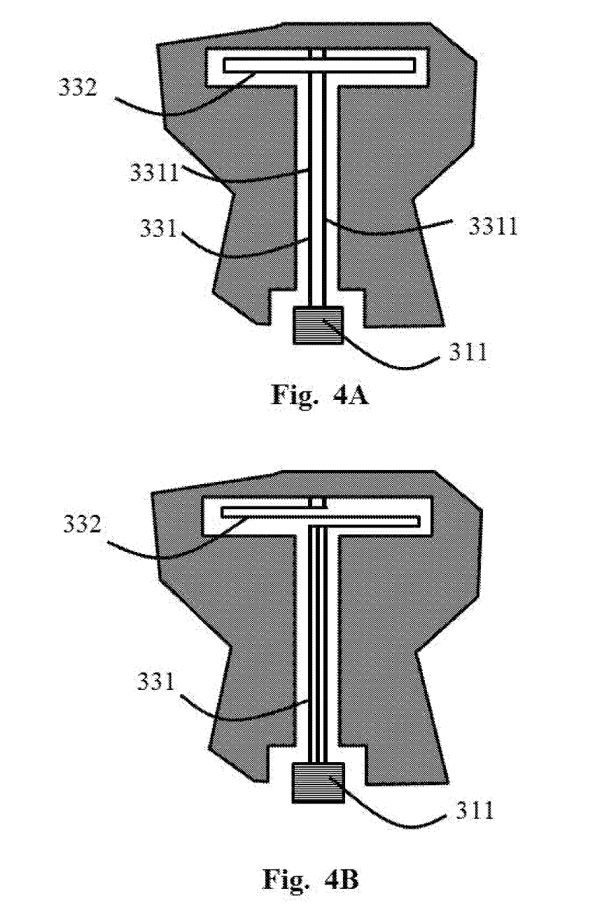

In the embodiment shown in FIG. 4A, the parallel-swing spring 331 includes two linear springs 3311 which are parallel to each other, and the compression spring 332 is a square ring spring. In the embodiment shown in FIG. 4B, the parallel-swing spring 331 includes three linear springs 3311 which are parallel to each other, and the compression spring 332 is an S-type spring. For simplicity in illustration, only one of the spring assembly 33 connected to one side of the anchor 311 is shown in FIGS. 4A and 4B. In a complete layout, the spring assemblies 33 are respectively connected to the opposite sides of the anchor 311 (as shown in FIG. 3). Note that the combinations of the parallel-swing spring 311 and the compression spring 332 in the spring assemblies 33 are not limited to the combination shown in FIGS. 4A and 4B. For example, the parallel-swing spring 311 can include three (or more) linear springs 3311 which are parallel to each other, and the compression spring 332 can be a spring other than the square ring spring or the S-type spring. The number of the linear springs 3311 in the parallel-swing spring 331 can be decided according to the effect that is desired to achieve. For example, the number of the linear springs 3311 in the parallel-swing spring 331 can be four or more, to even more reduce the motion-coupling effect of the out-of-plane torsion motion on the in-plane motion. However, when the number of the linear springs 3311 in the parallel-swing spring 331 increases, the rotation amplitude of the proof mass 32 is reduced whereby the sensitivity for sensing rotation is reduced. Therefore, the number of the linear springs 3311 in the parallel-swing spring 331 should be decided according to practical condition and requirements.

Referring to FIG. 3, there is a reference line passing through the anchor 311. The reference line can be the reference line AA′ or the reference line BB′; both of the reference lines AA′ and BB′ pass through the anchor 311. In one embodiment, the spring assemblies 33 are mirror-symmetrical with respect to the reference line AA′ (or the reference line BB′). The sensing capacitators 34 are mirror-symmetrical with respect to the reference line AA′ (or the reference line BB′). When the proof mass 32 is in motion, the sensing capacitors 34 mirror-symmetrical with respect to the reference line AA′ (or BB′) can function as differential capacitors for better sensing the motion of the proof mass 32.

Still referring to FIG. 3, the proof mass 32 is a one-integral-piece mass structure made of one same material, with direct connection between all portions of the proof mass 32. “One-integral-piece mass structure of one same material” means that there is no other portion of the proof mass indirectly connected to the proof mass 32 by a material which is not the material of the proof mass 32. The spring assemblies 33 and the sensing capacitors 34 are located inside the proof mass 32 (inside an area encompassed by the outer periphery of the proof mass 32), that is, there is space inside the outer periphery of the proof mass 32. Because the proof mass 32 is one-integral-piece mass structure of one same material, every portion of the proof mass 32 has the same displacement, displacement direction, and rotation as other portions.

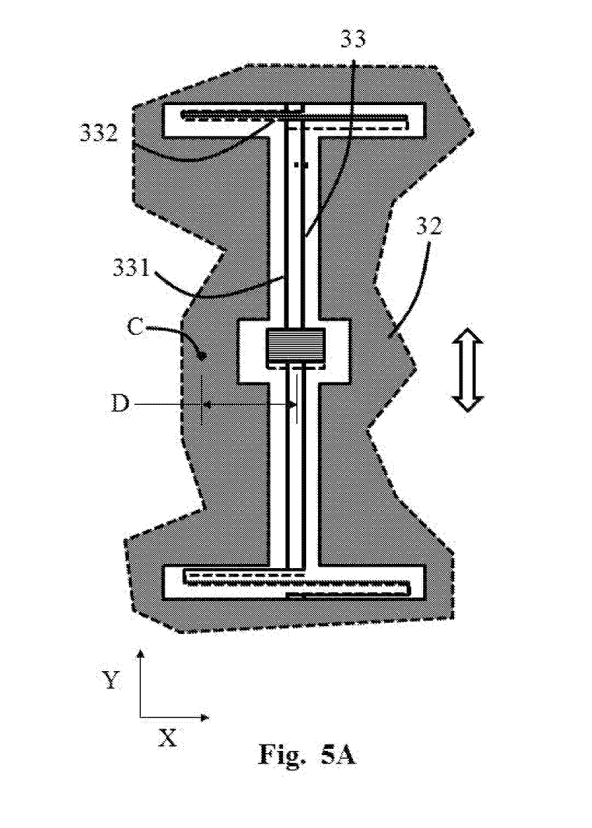

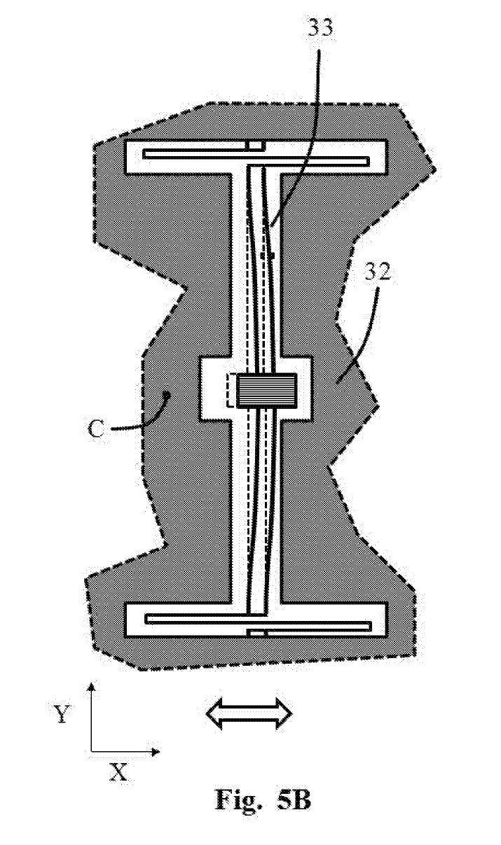

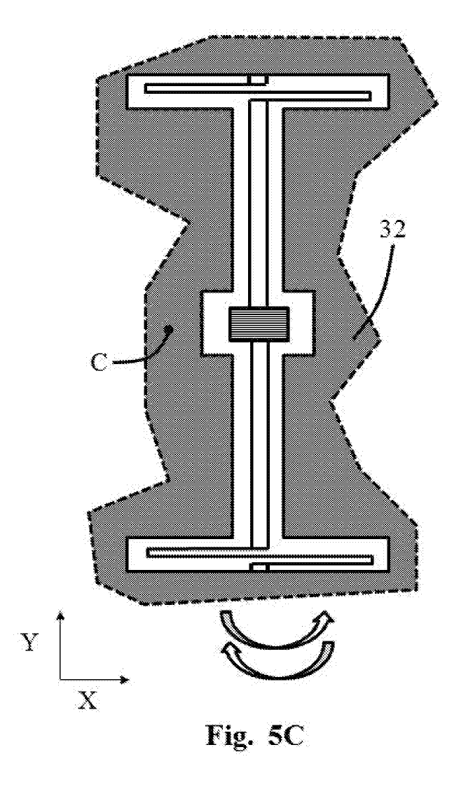

FIGS. 5A and 5B show two types of the in-plane motions of the proof mass 32. FIG. 5A show the in-plane motion in a direction Y, and FIG. 5B show the in-plane motion in a direction X, wherein the direction X is perpendicular to the direction Y. In FIG. 5C, the spring assemblies 33 assist the proof mass 32 in the out-of-plane torsion motion, wherein the out-of-plane torsion motion can be a seesaw motion with a rotation axis parallel to the direction X (such that the rotation along the axis is in the out-of-plane direction of the substrate 31). When the MEMS device 30 is moved in the out-of-plane direction, the eccentric layout causes the out-of-plane torsion motion of the proof mass 32.

Note that in the present invention, the eccentric design of the proof mass 32 has very limited influence on the displacements in the directions X and Y. First, the parallel-swing springs 331 are able to restrain the proof mass 32 from rotation with respect to the direction Y (rotation with axis in Y direction). Second, in a view along the direction X, the centroid C and the anchor 311 overlap, so the displacement in the direction X is not affected by the eccentric design. In a view alone the direction Y, there is a distance D is between the centroid C and the anchor 311, but the displacement of the proof mass 32 in the direction Y is hardly affected by the eccentric design because of the parallel-swing springs 331 (as shown in FIG. 5A, the compression springs 332 deform in the direction Y, but the parallel-swing springs 331 do not deform).

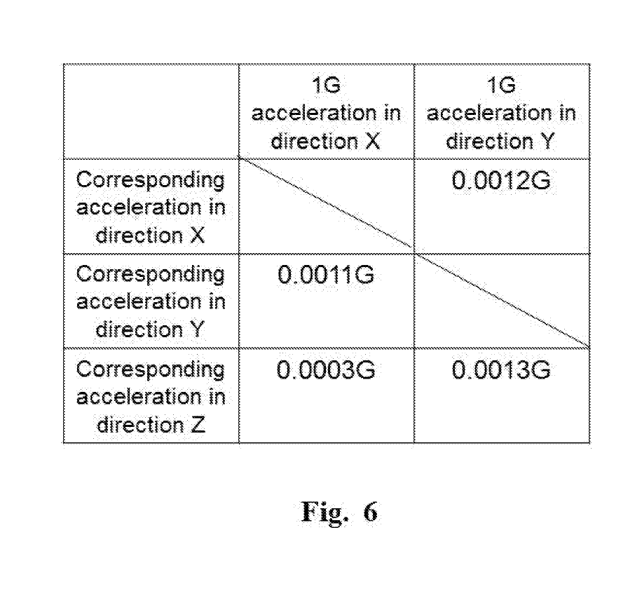

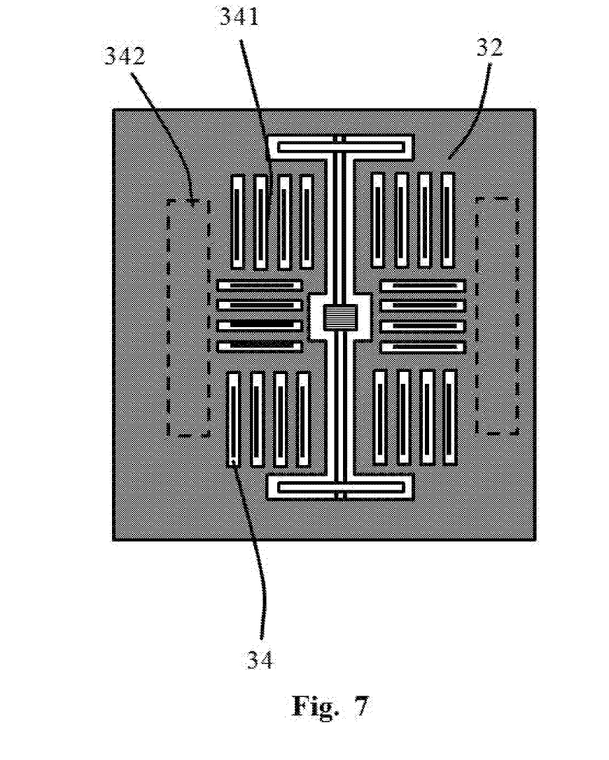

Please refer to FIG. 6, wherein the motion-coupling effects of the proof mass 32 in different directions are shown according to one embodiment of the present invention. When the proof mass 32 has an acceleration in the direction X or Y, the coupled accelerations in different directions are shown in the table. As illustrated, when the proof mass 32 has the acceleration 1 G in the direction X, the coupled acceleration in the direction Y is 0.0011 G, and the coupled acceleration in the direction Z is 0.0003 G, which are ignorable. Hence, the parallel-swing springs 331 can reduce the motion-coupling effects of the proof mass 32 in different directions, better than the prior art.

As described with reference to the above embodiments, the proof mass 32 can perform the in-plane motion (FIGS. 5A and 5B) or the out-of-plane torsion motion (FIG. 5C). The in-plane motion can be a motion in the direction X alone, or a motion in the direction Y alone, or a combination. In one embodiment, the proof mass 32 is one-integral-piece mass structure of one same material with direct connection between all portions of the proof mass, and the motion of the proof mass 32 assisted by the spring assemblies 33 can simultaneously include in-plane motions and an out-of-plane torsion motion.

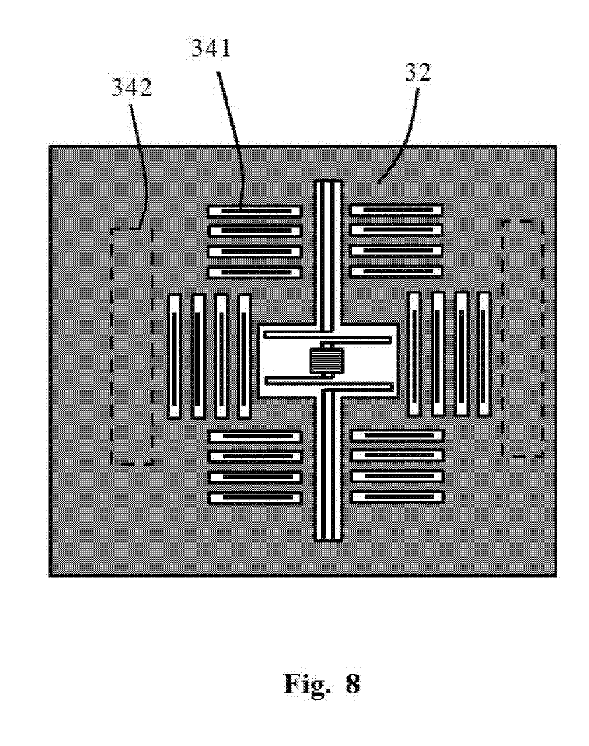

In the embodiments shown in FIGS. 3, 7, and 8, the sensing capacitors 34 include plural in-plane sensing capacitators 341 and plural out-of-plane sensing capacitators 342. The differences between the embodiments include: the layout relationship between the locations of the X-direction sensing capacitors (vertically disposed electrodes in figures) and the locations of the Y-direction sensing capacitors (laterally disposed electrodes in figures) in the in-plane sensing capacitator 341, and the connection relationship between the parallel-swing spring 331 and compression spring 332. In FIGS. 3, 7, and 8, a portion of the proof mass 32 surrounds an outer periphery of the in-plane sensing capacitators 341. In one embodiment, the out-of-plane sensing capacitators 342 are located between the substrate 31 and two lateral side portions of the proof mass 32. For example, the out-of-plane sensing capacitators 342 are located at the outer side of the in-plane sensing capacitators 341.

In FIG. 3, the anchor 311 is located in a center area of the substrate 31. For example, the anchor 311 can be located in an area within one quarter or one fifth (measured by the side length in one dimension) of the substrate 31 around the center. The size of the center area can be decided according to the requirements of the anchor and the performance of the substrate 31. In one embodiment, the in-plane sensing capacitators 341 are located in an area within one half (measured by the side length in one dimension) of the substrate 31 around the center, such that the sensitivities of the in-plane sensing capacitators 341 are not affected by the thermal offset in the substrate 31. If necessary, the in-plane sensing capacitators 341 can be located in a smaller area around the anchor 311. For example, the smaller area can be in an area within one third or one fourth (measured by the side length in one dimension) of the substrate 31 around the center.

In the embodiments according to FIGS. 4A and 4B, each of the two opposite sides of the anchor 311 is directly connected to one of the spring assemblies 33. Unlike prior art, there is no linkage connected between the anchor 311 and the spring assemblies 33 in the present invention. The prior art linkage is provided to reduce the motion-coupling effect or the undesired offset of the proof mass in another direction. The spring assembly of the present invention can reduce the motion-coupling effect and the undesired offset, so that the linkage between the anchor and the spring assembly is not required.

The present invention has been described in considerable detail with reference to certain preferred embodiments thereof. It should be understood that the description is for illustrative purpose, not for limiting the scope of the present invention. The abstract and the title are provided for assisting searches and not to be read as limitations to the scope of the present invention. Those skilled in this art can readily conceive variations and modifications within the spirit of the present invention; for example, an embodiment or a claim of the present invention does not need to attain or include all the objectives, advantages or features described in the above. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment.

What is claimed is:

1. A MEMS device, comprising:
a substrate, including an anchor;
a proof mass, including a centroid, the centroid being away from the anchor by a distance;
at least two spring assemblies, respectively connected between the proof mass and two opposite sides of the anchor, to assist a motion of the proof mass, wherein each of the spring assemblies includes a parallel-swing spring and a compression spring which are connected in series; and
a plurality of sensing capacitators, located between the substrate and the proof mass, to sense the motion of the proof mass.

2. The MEMS device of claim 1, further comprising a reference line passing through the anchor, wherein the spring assemblies are mirror-symmetrical with respect to the reference line, and the sensing capacitators are mirror-symmetrical with respect to the reference line.

3. The MEMS device of claim 1, wherein the motion of the proof mass includes: an in-plane motion, an out-of-plane torsion motion, or a combination of the in-plane motion and the out-of-plane torsion motion, wherein the in-plane motion is parallel to an in-plane direction with respect to the substrate and the out-of-plane torsion motion is parallel to an out-of-plane direction with respect to the substrate.

4. The MEMS device of claim 3, wherein the sensing capacitors include a plurality of in-plane sensing capacitators and a plurality of out-of-plane sensing capacitators, and a portion of the proof mass surrounds an outer periphery of the in-plane sensing capacitators.

5. The MEMS device of claim 4, wherein the out-of-plane sensing capacitators are located between the substrate and two lateral side portions of the proof mass.

6. The MEMS device of claim 3, wherein the in-plane motion includes two in-plane motion directions which are mutually perpendicular to each other.

7. The MEMS device of claim 1, wherein the parallel-swing spring includes at least two linear springs which are parallel to each other.

8. The MEMS device of claim 1, wherein the two spring assemblies respectively directly connect two opposite sides of the anchor.

9. The MEMS device of claim 1, wherein the anchor is located in a center area of the substrate.

10. The MEMS device of claim 1, wherein the compression spring includes: an S-type spring or a square ring spring.

11. The MEMS device of claim 1, wherein the proof mass is one-integral-piece mass structure of one same material with direct connection between all portions of the proof mass.

12. The MEMS device of claim 8, wherein the spring assemblies directly connect the anchor, without any linkage between the anchor and the spring assemblies.
